(19) United States
(12) Patent Application Publication
(10) Pub. No.: US 2025/0232476 A1
(43) Pub. Date: Jul. 17, 2025

(54) ZIPPERING SEI MESSAGE

(71) Applicants: SONY GROUP CORPORATION, Tokyo (JP); Sony Corporation of America, New York, NY (US)

(72) Inventor: Danillo Graziosi, Flagstaff, AZ (US)

(21) Appl. No.: 18/677,008

(22) Filed: May 29, 2024

Related U.S. Application Data
(60) Provisional application No. 63/621,329, filed on Jan. 16, 2024.

(51) Int. Cl. G06T 9/00; G06T 9/20

(52) U.S. Cl. CPC G06T 9/001; G06T 9/20

(57) ABSTRACT

A zippering algorithm includes following steps: find border vertices, according to the method, either derive the matching borders from distance search or use the matches provided in the SEI message, and fuse the matched borders. A fast search algorithm ignores vertices that are already matches, ignores vertices with a distance greater than a limit and is only utilized for border vertices.

### CROSS-REFERENCE TO RELATED APPLICATION(S)

This application claims priority under 35 U.S.C. § 119(e) of the U.S. Provisional Patent Application Ser. No. 63/621,329, filed Jan. 16, 2024 and titled, “ZIPPERING SEI MESSAGE,” which is hereby incorporated by reference in its entirety for all purposes.

### FIELD OF THE INVENTION

The present invention relates to three dimensional graphics. More specifically, the present invention relates to coding of three dimensional graphics.

### BACKGROUND OF THE INVENTION

Recently, a novel method to compress volumetric content, such as point clouds, based on projection from 3D to 2D is being standardized. The method, also known as V3C (visual volumetric video-based compression), maps the 3D volumetric data into several 2D patches, and then further arranges the patches into an atlas image, which is subsequently encoded with a video encoder. The atlas images correspond to the geometry of the points, the respective texture, and an occupancy map that indicates which of the positions are to be considered for the point cloud reconstruction.

In 2017, MPEG had issued a call for proposal (CfP) for compression of point clouds. After evaluation of several proposals, currently MPEG is considering two different technologies for point cloud compression: 3D native coding technology (based on octree and similar coding methods), or 3D to 2D projection, followed by traditional video coding. In the case of dynamic 3D scenes, MPEG is using a test model software (TMC2) based on patch surface modeling, projection of patches from 3D to 2D image, and coding the 2D image with video encoders such as HEVC. This method has proven to be more efficient than native 3D coding, and is able to achieve competitive bitrates at acceptable quality.

Due to the success for coding 3D point clouds of the projection-based method (also known as the video-based method, or V-PCC), the standard is expected to include in future versions further 3D data, such as 3D meshes. However, current version of the standard is only suitable for the transmission of an unconnected set of points, so there is nomechanism to send the connectivity of points, as it is required in 3D mesh compression.

Methods have been proposed to extend the functionality of V-PCC to meshes as well. One possible way is to encode the vertices using V-PCC, and then the connectivity using a mesh compression approach, like TFAN or Edgebreaker. The limitation of this method is that the original mesh has to be dense, so that the point cloud generated from the vertices is not sparse and can be efficiently encoded after projection. Moreover, the order of the vertices affect the coding of connectivity, and different method to reorganize the mesh connectivity have been proposed. An alternative way to encode a sparse mesh is to use the RAW patch data to encode the vertices position in 3D. Since RAW patches encode (x,y,z) directly, in this method all the vertices are encoded as RAW data, while the connectivity is encoded by a similar mesh compression method, as mentioned before. Notice that in the RAW patch, the vertices may be sent in any preferred order, so the order generated from connectivity encoding can be used. The method can encode sparse point clouds, however, RAW patches are not efficient to encode 3D data, and further data such as the attributes of the triangle faces may be missing from this approach.

### SUMMARY OF THE INVENTION

A zippering algorithm includes following steps: find border vertices, according to the method, either derive the matching borders from distance search or use the matches provided in the SEI message, and fuse the matched borders. A fast search algorithm ignores vertices that are already matches, ignores vertices with a distance greater than a limit and is only utilized for border vertices.

In one aspect, a method programmed in a non-transitory memory of a device comprises storing vertex information in a data structure, determining a distance between a current vertex and a second vertex, indicating a match between the current vertex and the second vertex when the distance is less than a threshold and fusing matched borders based on the match between the current vertex and the second vertex. The method further comprises receiving input information including: a vertex count, a submesh count, vertex coordinates and an indicator of a boundary vertex, wherein the input information is utilized for fusing matched borders. When the indicator of the boundary vertex indicates that the current vertex is not a boundary vertex, then the current vertex is skipped. When a match is indicated for the current vertex based on a previous vertex match, then the current vertex is skipped. When the distance between the current vertex and the second vertex is zero, the current vertex is skipped. The method further comprises comparing an index of a submesh of the current vertex and the index of the submesh of the second vertex, and when the index of the submesh of the current vertex and the index of the submesh of the second vertex are the same, the second vertex is skipped. The data structure comprises an array.

In another aspect, an apparatus comprises a non-transitory memory for storing an application, the application for storing vertex information in a data structure, determining a distance between a current vertex and a second vertex, indicating a match between the current vertex and the second vertex when the distance is less than a threshold and fusing matched borders based on the match between the current vertex and the second vertex and a processor coupled to the memory, the processor configured for processing the application. The application is further configured for receiving input information including: a vertex count, a submesh count, vertex coordinates and an indicator of a boundary vertex, wherein the input information is utilized for fusing matched borders. When the indicator of the boundary vertex indicates that the current vertex is not a boundary vertex, then the current vertex is skipped. When a match is indicated for the current vertex based on a previous vertex match, then the current vertex is skipped. When the distance between the current vertex and the second vertex is zero, the current vertex is skipped. The application is further configured for comparing an index of a submesh of the current vertex and the index of the submesh of the second vertex, and when the index of the submesh of the current vertex and the index of the submesh of the second vertex are the same, the second vertex is skipped. The data structure comprises an array.

In another aspect, a system comprises an encoder configured for encoding content and a decoder configured for: storing vertex information of the content in a data structure, determining a distance between a current vertex and a second vertex, indicating a match between the current vertex and the second vertex when the distance is less than a threshold and fusing matched borders based on the match between the current vertex and the second vertex. The decoder is further configured for receiving input information including: a vertex count, a submesh count, vertex coordinates and an indicator of a boundary vertex, wherein the input information is utilized for fusing matched borders. When the indicator of the boundary vertex indicates that the current vertex is not a boundary vertex, then the current vertex is skipped. When a match is indicated for the current vertex based on a previous vertex match, then the current vertex is skipped. When the distance between the current vertex and the second vertex is zero, the current vertex is skipped. Wherein the decoder is further configured for comparing an index of a submesh of the current vertex and the index of the submesh of the second vertex, and when the index of the submesh of the current vertex and the index of the submesh of the second vertex are the same, the second vertex is skipped. The data structure comprises an array.

### BRIEF DESCRIPTION OF THE DRAWINGS

FIG. 1 illustrates diagrams of a zippering algorithm according to some embodiments.

FIG. 2 illustrates a diagram of a V-DMC V3C decoder according to some embodiments.

FIG. 3 illustrates a flowchart of a method of implementing a fast search algorithm according to some embodiments.

FIG. 4 illustrates a block diagram of an exemplary computing device configured to implement the mesh zippering method according to some embodiments.

### DETAILED DESCRIPTION OF THE PREFERRED EMBODIMENT

An SEI message has the option to fuse border vertices using a distance-based algorithm. However, this algorithm increases the decoding time. A new implementation of the distance-based zippering reduces the decoding time. A post-reconstruction step fuses the border vertices of the submeshes.

### SEI Zippering

A zippering algorithm includes the following steps: (1) find border vertices, (2) according to the method, either derive the matching borders from a distance search (method 1) or use the matches provided in the SEI message (method 2), (3) and fuse the matched borders.

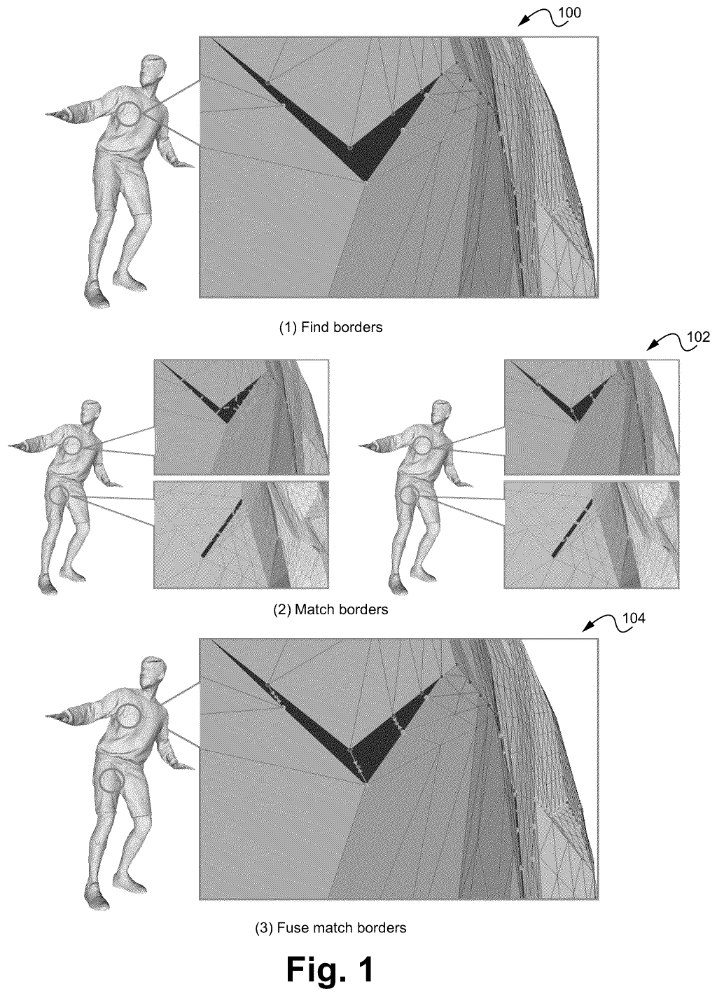

FIG. 1 illustrates diagrams of a zippering algorithm according to some embodiments. In the step 100, border points (vertices) are found. The border points are able to be found in any manner, such as based on the number of connections (e.g., if below a threshold, then the vertex is a border point).

After the border points are found, border matching is implemented, in the step 102. The border matching is able to be implemented using one or more different implementations. For example, border matching is able to be distance-based or index-matching.

In some embodiments, to find the matching points, a search is performed in the 3D space by searching neighboring points of a point. The search is able to be limited in scope (e.g., based on a fixed value such as a maximum distance of 5 or based on a maximum distortion). Therefore, if the distance is larger than 5, the point will never find its match. The distance to be searched is able to be per frame, per submesh, or per point, among other options.

A fast distance-based search is able to be implemented to reduce the time on distance-based searches for matching border points. The vertices are stored in a data structure (e.g., an array), and then the distances for the vertices are determined. The vertices are able to be ordered (e.g., based on the distance from another vertex). The vertices are also able to be grouped (e.g., vertices in the same submesh are in a same array). These organizational steps/implementations are able to be used to make the search faster. For example, vertices in the same submesh are not searched/compared. By utilizing the fast distance-based search, the decoding process is able to be much faster (e.g., 3× faster).

The search is able to utilize index matching where the point to point connections are implemented. For example, point 1 connects to point 5, and point 2 connects to point 12, and so on. The point to point connections are able to be stored in a database or other implementation.

In the step 104, vertices are merged or fused. Merging the vertices is able to be performed in any manner. For example, a point halfway between the two matching vertices to be merged is found, and that half-way point becomes the new vertex, replacing the previous two vertices. In some embodiments, fewer or additional steps are implemented. In some embodiments, the order of the steps is modified.

In some embodiments, a zippering algorithm is implemented using the SEI message on top of TMMv6.6. The table below shows the obtained results for 32 frames:

TABLE 1
32 frame result comparing the zippering method 2 (encoder option 5).
All Intra
C1_ai lossy geometry, lossy attributes [all intra]

| | Pointcloud-based | | Image-based BD Rate [%] | | | | |
|---|---|---|---|---|---|---|---|
| | BD Rate [%] | | Luma | Chroma | | | |
| | D1 | D2 | Cb | Cr | Chroma | Geom | Luma |
| Cat1-A average | 0.0% | 0.1% | 0.6% | 0.1% | 0.2% | −7.5% | −0.1% |
| Cat1-B average | −0.2% | 0.0% | 1.2% | 0.0% | 0.1% | −6.6% | −1.3% |
| Cat1-C average | −0.1% | 0.0% | 0.2% | 0.0% | 0.0% | −6.4% | −0.9% |
| Overall average | −0.1% | 0.0% | 0.6% | 0.1% | 0.1% | −6.7% | −0.8% |

| | |
|---|---|
| Avg. Enc Time [%] | 95% |
| Avg. Dec Time [%] | 385% |

Inter, Random Access
C2_ra lossy geometry, lossy attributes [inter, random access]

| | Pointcloud-based | | Image-based BD Rate [%] | | | | |
|---|---|---|---|---|---|---|---|
| | BD Rate [%] | | Luma | Chroma | | | |
| | D1 | D2 | Cb | Cr | Chroma | Geom | Luma |
| Cat1-A average | −0.5% | 0.0% | 3.6% | 0.5% | 0.2% | −23.5% | −1.0% |
| Cat1-B average | −0.2% | 0.0% | 1.2% | 0.0% | 0.1% | −6.5% | −1.3% |
| Cat1-C average | −0.1% | 0.0% | 0.1% | 0.0% | 0.0% | −5.0% | −0.7% |
| Overall average | −0.2% | 0.0% | 1.2% | 0.2% | 0.1% | −10.0% | −0.9% |

| | |
|---|---|
| Avg. Enc Time [%] | 99% |
| Avg. Dec Time [%] | 350% |

TABLE 2
All Intra
C1_ai lossy geometry, lossy attributes [all intra]

| | Pointcloud-based | | Image-based BD Rate [%] | | | | |
|---|---|---|---|---|---|---|---|
| | BD Rate [%] | | Luma | Chroma | | | |
| | D1 | D2 | Cb | Cr | Chroma | Geom | Luma |
| Cat1-A average | 5.5% | 5.5% | 6.6% | 5.5% | 5.6% | 0.8% | 5.8% |
| Cat1-B average | 5.8% | 5.8% | 8.9% | 6.5% | 6.8% | 1.3% | 5.7% |
| Cat1-C average | 7.4% | 7.2% | 8.2% | 8.4% | 8.4% | 3.0% | 6.8% |
| Overall average | 6.5% | 6.5% | 8.0% | 7.2% | 7.3% | 2.0% | 6.3% |

| | |
|---|---|
| Avg. Enc Time [%] | 99% |
| Avg. Dec Time [%] | 161% |

Inter, Random Access
C2_ra lossy geometry, lossy attributes [all intra]

| | Pointcloud-based | | | | | | |
|---|---|---|---|---|---|---|---|
| | BD Rate [%] | | Image-based BD Rate [%] | | | | |
| | D1 | D2 | Luma | Chroma | Chroma | Geom | Luma |
| Cat1-A average | 6.9% | 7.3% | 11.1% | 8.8% | 8.2% | −9.0% | 6.9% |
| Cat1-B average | 6.0% | 6.0% | 9.0% | 6.6% | 7.1% | 1.6% | 5.9% |
| Cat1-C average | 6.9% | 6.7% | 7.7% | 7.6% | 7.6% | 3.4% | 6.6% |
| Overall average | 6.7% | 6.7% | 8.9% | 7.6% | 7.6% | −0.1% | 6.5% |

| | |
|---|---|
| Avg. Enc Time [%] | 98% |
| Avg. Dec Time [%] | 129% |

As expected, the distance-based method (method 1) has the smallest overhead and the best performance, but the decoding time is much higher than the index-matching method (method 2). However, the implementation is using a non-optimized KD-tree search to find the best match. Therefore, a simple and fast distance-based search is described herein.

### New Fast Implementation

The search for matches takes a significant amount of time, specifically at the decoder side. Therefore, a fast distance-based search technique is implemented, which evaluates the minimum distance between border points from different submeshes only. Therefore, the usage of KD-tree is able to be avoided.

TABLE 3
All Intra
C1_ai lossy geometry, lossy attributes [all intra]

| | Pointcloud-based | | Image-based BD Rate [%] | | | | |
|---|---|---|---|---|---|---|---|
| | BD Rate [%] | | Luma | Chroma | | | |
| | D1 | D2 | Cb | Cr | Chroma | Geom | Luma |
| Cat1-A average | 0.0% | 0.1% | 0.6% | 0.1% | 0.2% | −7.5%-0.1% | |
| Cat1-B average | −0.2% | 0.0% | 1.2% | 0.0% | 0.1% | −6.6%-1.3% | |
| Cat1-C average | −0.2% | 0.0% | 0.2% | 0.0% | 0.0% | −6.4%-0.9% | |
| Overall average | −0.1% | 0.0% | 0.5% | 0.1% | 0.1% | −6.7%-0.8% | |

| | |
|---|---|
| Avg. Enc Time [%] | 103% |
| Avg. Dec Time [%] | 107% |

Inter, Random Access
C2_ra lossy geometry, lossy attributes [all intra]

| | Pointcloud-based | | Image-based BD Rate [%] | | | | |
|---|---|---|---|---|---|---|---|
| | BD Rate [%] | | Luma | Chroma | | | |
| | D1 | D2 | Cb | Cr | Chroma | Geom | Luma |
| Cat1-A average | −0.5% | 0.0% | 3.5% | 0.5% | 0.2% | −23.3% | −1.0% |
| Cat1-B average | −0.2% | 0.0% | 1.1% | 0.0% | 0.1% | −6.5% | −1.3% |
| Cat1-C average | −0.1% | 0.0% | 0.1% | 0.0% | 0.0% | −5.0% | −0.7% |
| Overall average | −0.2% | 0.0% | 1.2% | 0.1% | 0.1% | −10.0%-0.9% | |

| | |
|---|---|
| Avg. Enc Time [%] | 97% |
| Avg. Dec Time [%] | 101% |

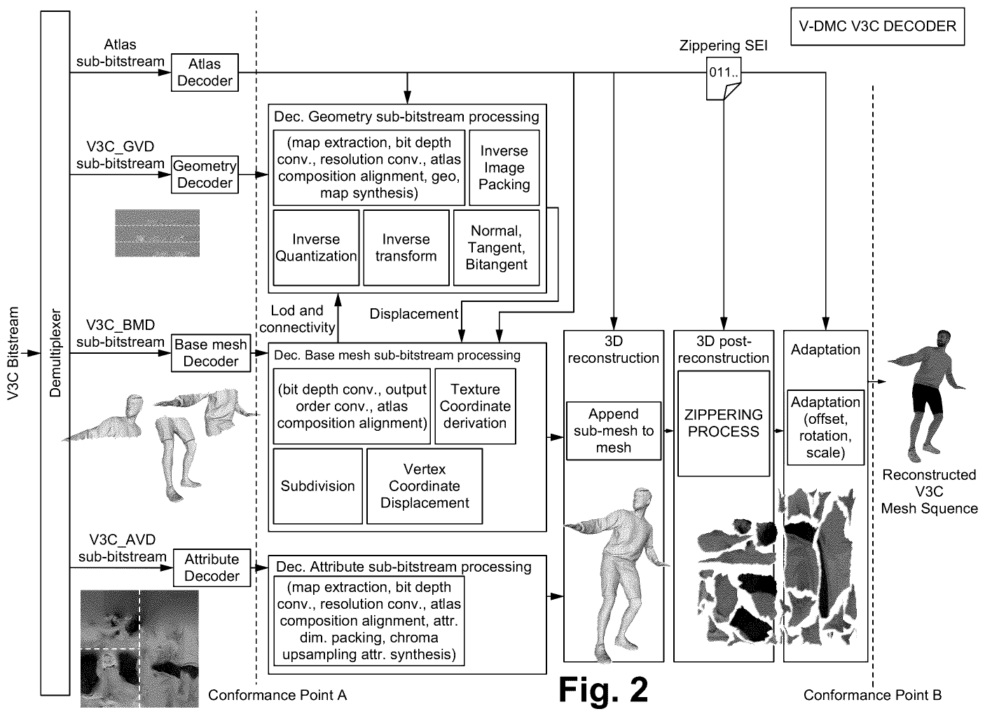

FIG. 2 illustrates a diagram of a V-DMC V3C decoder according to some embodiments. The V3C bitstream is received and separated into sub-bitstreams. The sub-bitstreams are then decoded. The decoded sub-bitstreams are then processed. 3D reconstruction generates a mesh. However, the mesh may have gaps. 3D post-reconstruction is implemented to address the gaps by utilizing the zippering process which closes the gaps as described herein. The zippering process is able to include processing the zippering SEI messages. The zippering SEI messages come from the Atlas decoder. After 3D post-reconstruction is adaptation, and ultimately, a V3C mesh sequence is reconstructed.

### Post-Reconstruction Process

The processes described are invoked for reconstructed mesh frames and syntax elements associated with the same atlas ID, identified by a variable postRecAtlasID.

The process is invoked after reconstructing the geometry and attributes for the current mesh frame with a composition time index compTimeIdx. The process takes as inputs the syntax elements and upper-case variables, and the following variables and arrays:
a variable verCoordCount, specifying the number of vertex coordinates in the reconstructed mesh frame,
a variable faceCount, specifying the number of faces in the reconstructed mesh frame,
a variable submeshCount, specifying the number of submeshes in the reconstructed mesh frame,
a 2D array recVerCoords, of size verCoordCount×3, specifying the reconstructed vertex coordinates,
a 2D array recVerCoordFaces, of size faceCount×3, specifying the reconstructed connectivity indices associated with the vertex coordinates,
a 1D array submeshVerCoordCount, of size submeshCount, specifying number of reconstructed vertices associated with the submesh,
   The outputs of this process are:
a 2D array zipVerCoords, of size verCoordCount×3, possibly modified by application of zippering.
   The following ordered steps apply:

Two 1D arrays, isBoundaryVertex and isModifiedVertex, of size verCoordCount, are initialized to 0. isBoundaryVertex specifies whether the reconstructed vertex is part of an edge located at the boundary of the mesh, that is, the edge belongs to a single triangle. isModifiedVertex specifies whether the reconstructed points were modified by zippering.

If the mesh reconstruction system has selected to use the m-th zippering instance for performing zippering operations during mesh reconstruction and the bitstream contains a zippering SEI message at the time instance compTimeIdx, the zippering process is invoked with variables m, verCoordCount, faceCount, and submeshCount and arrays recVerCoords, recVerCoordFaces, and submeshVerCoordCount as inputs. The outputs of this process are the array zipVerCoords, which contains the updated positions of the vertices in the current reconstructed mesh frame after zippering, and the updated arrays isBoundaryVertex, and isModifiedVertex.

A bitstream may contain multiple zippering filter instances. The mesh reconstruction system can choose an appropriate filter instance for zippering based on considerations such as computational complexity, power, and visual quality requirements.

### Zippering Process

The process is invoked when a bitstream contains a zippering SEI message, and the mesh reconstruction system has selected to use the m-th zippering instance for performing zippering during mesh reconstruction.

Inputs to the process are:
a variable m, specifying the zippering filter instance,
a variable verCoordCount, specifying the number of vertex coordinates in the reconstructed mesh frame,
a variable faceCount, specifying the number of faces in the reconstructed mesh frame,
a variable submeshCount, specifying the number of submeshes in the reconstructed mesh frame,
a 2D array recVerCoords, of size verCoordCount×3, specifying the reconstructed vertex coordinates,
a 2D array recVerCoordFaces, of size faceCount×3, specifying the reconstructed connectivity indices associated with the vertex coordinates,
a 1D array submeshVerCoordCount, of size submeshCount, specifying number of reconstructed vertices associated with the submesh.
   Outputs of this process are:
a 2D array zipVerCoords, of size verCoordCount×3, possibly modified by application of zippering,
a 1D array isModifiedVertex, of size verCoordCount, specifying whether the zippering process modified the position of the n-th reconstructed vertex, and
a 1D array isBoundaryVertex, of size verCoordCount, specifying whether the n-th reconstructed vertex is a boundary vertex of the reconstructed mesh.
   The following applies:

A variable zipMethod is set to zp_method_type[m].

An array isBoundaryVertex[n], n=0..verCoordCount−1, is initialized to 0.

An array isModifiedVertex[n], n=0..verCoordCount−1, is initialized to 0.

An array zipVerCoords[n][k], n=0..verCoordCount−1, k=0..2, is initialized using the array recVerCoords[n][k] as follows:

$$for ( n = 0 ; n < verCoordCount ; n ++ )$$

$$for ( k = 0 ; n < 3 ; k ++ )$$

$$zipVerCoords [ n ] [ k ] = recVerCoords [ n ] [ k ]$$

First, the boundary vertices are identified using a procedure with variables verCoordCount, faceCount, and arrays recVerCoords and recVerCoordFaces as inputs, and array isBoundaryVertex as output.

If zipMethod is equal to 1, then a procedure is invoked with variables m, verCoordCount, faceCount, and submeshCount and arrays recVerCoords, recVerCoordFaces, submeshVerCoordCount, and isBoundaryVertex as inputs, and arrays zipMatchSubmeshIdx and zipMatchBorderIdx as outputs. Otherwise, if zipMethod is equal to 2, then the following variables are derived:

```
numSubmeshes = zp_number_of_submeshes[ m ]
for( smIdx = 0; smIdx < numSubmeshes; smIdx++ ) {
  borderCount[ smIdx ] = zp_number_of_border_points[ k ][ smIdx ]
  for( bIdx = 0; bIdx < borderCount[ smIdx ]; bIdx++ ) {
    zipMatchSubmeshIdx[ smIdx ][ bIdx ] =
    zp_border_point_match_submesh_index[ m ][ smIdx ][ bIdx ]
    zipMatchBorderIdx[ smIdx ][ bIdx ] =
      zp_border_point_match_border_point_index[ m ][ smIdx ][
      bIdx ]
  }
}
```

Then, the following process applies:

```
  pointIdx = 0
  for( smIdx = 0; smIdx < numSubmeshes; smIdx++ ) {
    bIdx = 0
    for( vIdx = 0; vIdx < submeshVerCoordCount[ smIdx ]; vIdx++ ) {
      if( isBoundaryVertex[ pointIdx ] ){
        matchedBorderPointFlag[ smIdx ][ bIdx ] = 0
        submeshIdx[ pointIdx ] = smIdx
        submeshVertexIdx[ pointIdx ] = bIdx
        bIdx = bIdx + 1
      }
      pointIdx = pointIdx + 1
    }
  }
  for( idx = 0; idx < verCoordCount; idx++ ) {
    if( isBoundaryVertex[ idx ] ){
      curVerCoord = zipVerCoords[ idx ]
      curSubmeshIdx = submeshIdx[ idx ]
      curBorderIdx = submeshVertexIdx[ idx ]
      if( !matchedBorderPointFlag[ smIdx ][ bIdx ] ){
        matchedSubmeshIdx = zipMatchSubmeshIdx[ curSubmeshIdx ][
curBorderIdx ]
        matchedBorderIdx = zipMatchBorderIdx[ curSubmeshIdx ][
curBorderIdx ]
        matchedIdx = 0
        for( i = 0; i < matchedSubmeshIdx; i++)
          matchedIdx = matchedIdx + borderCount[ smIdx ]
        borderIdx = 0
        for( i = 0; i < borderCount[ smIdx ]; i++)
          if( isBoundaryVertex[ matchedIdx +i ] ){
            if( borderIdx == matchedBorderIdx )
              matchedIdx = matchedIdx + i
            else
              borderIdx = borderIdx + 1
          }
        }
        matchedVerCoord = zipVerCoords[ matchedIdx ]
        if( matchedBorderPointFlag[ matchedSubmeshIdx ][
matchedBorderIdx ] ){
          for( k = 0; n < 3; k++ )
            curVerCoord[ k ] = matchedVerCoord[ k ]
          isModifiedVertex[ idx ] = 1
        } else {
          for( k = 0; n < 3; k++ )
            avgVerCoord[ k ] = ( curVerCoord[ k ] +
matchedVerCoord[ k ] ) / 2
          for( k = 0; n < 3; k++ )
            curVerCoord[ k ] = avgVerCoord[ k ]
          isModifiedVertex[ idx ] = 1
          for( k = 0; n < 3; k++ )
            matchedVerCoord[ k ] = matchedVerCoord[ k ]
          isModifiedVertex[ matchedIdx ] = 1
        }
      }
  }
```

### Identification of Boundary Vertices

The process identifies a vertex on a mesh as a boundary vertex if the vertex lies on an edge being used by a single triangle. Zippering should be applied only to vertices which correspond to such boundary vertices.

Inputs to the process are:
a variable verCoordCount, specifying the number of vertex coordinates in the reconstructed mesh frame,
a variable faceCount, specifying the number of faces in the reconstructed mesh frame,
a 2D array recVerCoords, of size verCoordCount×3, specifying the reconstructed vertex coordinates,
a 2D array recVerCoordFaces, of size faceCount×3, specifying the reconstructed connectivity indices associated with the vertex coordinates,

Outputs of the process are:
a 1D array isBoundaryVertex, of size verCoordCount, specifying whether the n-th reconstructed vertex is a boundary vertex of the reconstructed mesh.
   The following applies:

```
  ComputeNeighbours( faceCount, recVerCoordFaces, verNeighbours,
verNeighbourCounts)
  ComputeTriangleNeighbours( faceCount, recVerCoordFaces,
triNeighbours, triNeighbourCounts)
  for( vIdx = 0; vIdx < verCoordCount; vIdx++ )
    isBoundaryVertex[ vIdx ] = 0
  for( fIdx = 0; fIdx < faceCount; fIdx++ )
    faceTag[ fIdx ] = −1
  for( vIdx = 0; vIdx < verCoordCount; vIdx++ )
    for( m = 0; m < neighbourCounts[ n ]; m++ )
      adj = neighbours[ vIdx ][ m ]
      if( adj > vIdx ){
        //mark all triangles connected to vIdx as 0
        for( n = 0; n < triNeighbourCounts[ vfdx ]; m++ ){
          fIdx = neighbours[ vIdx ][ n ]
          faceTag[ fIdx ] = 0
        }
        //mark all triangles connected to adj as 1
        for( n = 0; n < triNeighbourCounts[ adj ]; m++ ){
          fIdx = neighbours[ adj ][ n ]
          faceTag[ fIdx ] = 1
        }
        //now for all triangles connected to vIdx, add the tags different
than 0
        counter = 0
        for( n = 0; n < triNeighbourCounts[ vfdx ]; m++ ){
          if( faceTag[ fIdx ] != 0 )
            counter = counter + 1
        }
        //if the counter is equal to 1, then this is a boundary vertex
        if( counter == 1 ) {
          isBoundaryVertex[ vIdx ] = 1
          isBoundaryVertex[ adj ] = 1
        }
      }
    }
  }
```

### Distance-Based Matched Search

Inputs to this process are:
a variable m, specifying the zippering filter instance,
a variable verCoordCount, specifying the number of vertex coordinates in the reconstructed mesh frame,
a variable submeshCount, specifying the number of submeshes in the reconstructed mesh frame,
a 2D array recVerCoords, of size verCoordCount×3, specifying the reconstructed vertex coordinates,
a 1D array submeshVerCoordCount, of size submeshCount, specifying number of reconstructed vertices associated with the submesh,
a 1D array isBoundaryVertex, of size verCoordCount, specifying whether the n-th reconstructed vertex is a boundary vertex of the reconstructed mesh.

Outputs of the process are:
a 2D array zipMatchSubmeshIdx, of size submeshCount×submeshVerCoordCount[i], specifying the submesh index of the matched border point,
a 2D array zipMatchBorderIdx, of size submeshCount×submeshVerCoordCount[i], specifying the border index of the matches border point.
   The following applies:

```
pointIdx = 0
for( smIdx = 0; smIdx < numSubmeshes; smIdx++ ) {
  bIdx = 0
  for( vIdx = 0; vIdx < submeshVerCoordCount[ smIdx ]; vIdx++ ) {
    if( isBoundaryVertex[ pointIdx ] ){
      matchedBorderPointFlag[ smIdx ][ bIdx ] = 0
      submeshIdx[ pointIdx ] = smIdx
      submeshVertexIdx[ pointIdx ] = bIdx
      bIdx = bIdx + 1
    }
    pointIdx = pointIdx + 1
  }
  boundaryCount[ smIdx ] = bIdx
}
maxDistance = zp_max_match_distance[ m ]
```

If the maxDistance is equal to 0, it indicates that the distance between border points is zero, indicating that there are no gaps between the submeshes, and zippering is not necessary, so load the output indicating no matches in the following way:

```
for( smIdx = 0; smIdx < submeshCount; smIdx++ ) {
  for( bIdx = 0; bIdx < boundaryCount[ smIdx ]; bIdx++ ) {
    zipMatchSubmeshIdx[ smIdx ][ bIdx ] = submeshCount
    zipMatchBorderIdx[ smIdx ][ bIdx ] = −1
  }
}
```

Otherwise, calculate the array of distance between border points in the following way:

```
  if( zp_send_distance_per_submesh[ m ] ){
    numSubmesh = zp_number_of_submeshes[ m ]
    for( smIdx = 0; smIdx < numSubmesh; smIdx++ ) {
      smMaxDistance = zp_max_match_distance_per_submesh[ m ][
      smIdx ]
      if( smMaxDistance == 0 ){
        for( bIdx = 0; bIdx < boundaryCount[ smIdx ]; bIdx++ ) {
          zipBoundaryDistance[ smIdx ][ bIdx ] = smMaxDistance
        }
      } else {
        if( zp_send_distance_per_border_point[ m ][ smIdx ] ){
          bCount = zp_number_of_border_points[ m ][ smIdx ]
          for( bIdx = 0; bIdx < bCount; bIdx++ ) {
            zipBoundaryDistance[ smIdx ][ bIdx ] =
              zp_border_point_distance[ m ][ smIdx ][
bIdx ]
          }
        } else {
          for( bIdx = 0; bIdx < boundaryCount[ smIdx ]; bIdx++ ) {
            zipBoundaryDistance[ smIdx ][ bIdx ] =
smMaxDistance
          }
        }
      }
    } } else {
    for( smIdx = 0; smIdx < submeshCount; smIdx++ ) {
      for( bIdx = 0; bIdx < boundaryCount[ smIdx ]; bIdx++ ) {
        zipBoundaryDistance[ smIdx ][ bIdx ] = maxDistance
      }
    }
  }
```

The distance array is used to find the best match between border points, as follows:

```
  for( pIdx = 0; pIdx < verCoordCount; pIdx++ ) {
    if( isBoundaryVertex[ pIdx ] ){
      smIdx = submeshIdx[ pIdx ]
      bIdx= submeshVertexIdx[ pIdx ]
      vertex = recVerCoords[ pIdx ]
      if( matchedBorderPointFlag[ smIdx ][ bIdx ] == 1 )
        continue
      // initialize the structure
      zipMatchSubmeshIdx[ smIdx ][ bIdx ] = submeshCount
      zipMatchBorderIdx[ smIdx ][ bIdx ] = −1
      // find all nearest points from other submeshes
      minDist = zipBoundaryDistance[ smIdx ][ bIdx ]
      for( pMatchIdx = 0; pMatchIdx < verCoordCount; pMatchIdx++
      ) {
        if( isBoundaryVertex[ pMatchIdx ] ){
          smMatchedIdx = submeshIdx[ pIdx ]
          bMatchedIdx= submeshVertexIdx[ pIdx ]
          matchedVertex = recVerCoords[ pMatchIdx ]
          if( smIdx == smMatchedIdx )
            continue
          distance = 0
          for( k =0; k < 3; k++ ){
            diff = vertex[ k ] − matchedVertex[ k ]
            distance = distance + diff * diff
          }
          if( distance < minDist ){
            minDist = distance
            zipMatchSubmeshIdx[ smIdx ][ bIdx ] =
smMatchedIdx
            zipMatchBorderIdx[ smIdx ][ bIdx ] = bMatchedIdx
          }
        }
      }
      if( zipMatchSubmeshIdx[ smIdx ][ bIdx ] != submeshCount ){
        matchedBorderPointFlag[ smIdx ][ bIdx ] = 1
        smMatchedIdx = zipMatchSubmeshIdx[ smIdx ][ bIdx ]
        bMatchedIdx = zipMatchBorderIdx[ smIdx ][ bIdx ]
        if( matchedBorderPointFlag[ smMatchedIdx ][ bMatchedIdx ]
== 0 ){
          matchedBorderPointFlag[ smMatchedIdx ][ bMatchedIdx ]
= 1
          zipMatchSubmeshIdx[ smMatchedIdx ][ bMatchedIdx ] =
smIdx
          zipMatchBorderIdx[ smMatchedIdx ][ bMatchedIdx ] =
bIdx
        }
      }
    }
  }
```

The specifications in ISO/IEC 23090-5(2E):2023 apply with the following additions to Table F-1:

TABLE F-1
The essential and non-essential SEI messages

| | | |
|---|---|---|
| SEI message | NAL Type | Conformance Type |
| Zippering | NAL_PREFIX_ESEI | Type-B |
| Submesh SOI relationship indication | NAL_PREFIX_NSEI/ | N/A |

NAL_SUFFIX_NSEI

Submesh distortion indicationNAL_PREFIX_NSEI/ N/A

NAL_SUFFIX_NSEI

### SEI Payload Syntax

The specifications in ISO/IEC 23090-5(2E):2023 Annex F.2 and its subclauses apply, with the following additions:

V-DMC registered SEI message syntax

| | |
|---|---|
| vdmc_registered_sei_message( payloadSize ) { | Descriptor |

```
  vdmcPayloadType = 0
  headerSize = 0
  do {
```

| | |
|---|---|
| vrsm_payload_type_byte | u(8) |

```
    vmdcPayloadType += vrsm_payload_type_byte
    headerSize += 1
  } while( vrsm_payload_type_byte == 0xFF )
  vdmcPayloadSize = payloadSize − headerSize
  vdmc_registered_sei_payload( vdmcPayloadType, vdmcPayloadSize )
}
V-DMC registered SEI message syntax
```

| | |
|---|---|
| vdmc_registered_sei_payload( vdmcPayloadType, vdmcPayloadSize ) { | Descriptor |

```
  if( vdmcPayloadType == 0 )
    zippering( vdmcPayloadSize )
  if( vdmcPayloadType == 1 )
    submesh_soi_relationship_indication( vdmcPayloadSize )
  if( vdmcPayloadType == 2 )
    submesh_distortion_indication( vdmcPayloadSize )
  else
    reserved_message( vdmcPayloadSize )
}
Zippering SEI payload syntax
```

| | |
|---|---|
| zippering( payloadSize ) { | Descriptor |
| zp_persistence_flag | u(1) |
| zp_reset_flag | u(1) |
| zp_instances_updated | u(8) |

for( i = 0; i < zp_instances_updated; i++ ) {

| | |
|---|---|
| zp_instance_index[ i ] | u(8) |

k = zp_instance_index[ i ]

| | |
|---|---|
| zp_instance_cancel_flag[ k ] | u(1) |

```
    if( zp_instance_cancel_flag[ k ] != 1 ) {
      zp_method_type[ k ] ue(v)
      if( zp_method_type[ k ] == 1 ) {
```

| | |
|---|---|
| zp_max_match_distance[ k ] | ue(v) |

if( zp_max_match_distance_per_frame[ k ] != 0 ) {

| | |
|---|---|
| zp_send_distance_per_submesh[ k ] | u(1) |

if( zp_send_distance_per_submesh[ k ] ) {

| | |
|---|---|
| zp_number_of_submeshes[ k ] | ue(v) |

```
            numSubmeshes = zp_number_of_submeshes[ k ]
            for( p = 0; p < numSubmeshes ; p++ ) {
              zp_max_match_distance_per_submesh[ k ][
```

| | |
|---|---|
| p ] | u(v) |

```
              if( zp_max_match_distance_per_submesh[ k
][ p ] != 0 ) {
                zp_send_distance_per_border_point[
```

| | |
|---|---|
| k ][ p ] | u(1) |

if(
zp_send_distance_per_border_point[ k ][ p ] == 1 ) {

| | |
|---|---|
| zp_number_of_border_points[ k ][ p ] | ue(v) |

```
                  numBorderPoints =
  zp_number_of_border_points[ k ][ p ]
                  for( b = 0; b <
numBorderPoints ; b++ )
```

| | |
|---|---|
| zp_border_point_distance[ k ][ p ][ b ] | u(v) |

```
                }
              }
            }
          }
        }
      }
      if( zp_method_type[ k ] == 2 ) {
```

| | |
|---|---|
| zp_number_of_submeshes[ k ] | ue(v) |
| numSubmeshes = zp_number_of_submeshes[ k ] | ue(v) |

for( p = 0; p < numSubmeshes; p++ )

| | |
|---|---|
| zp_number_of_border_points[ k ][ p ] | ue(v) |

```
        for( p = 0; p < numSubmeshes; p++ ) {
          numBorderPoints = zp_number_of_border_points[ k ][ p ]
          for( b = 0; b < numBorderPoints ; b++ ) {
            if( zipperingBorderPointMatchIndexFlag[ k ][ p ][ b
] == 0) {
              zp_border_point_match_submesh_index[ k
```

| | |
|---|---|
| ][ p ][ b ] | u(v) |

```
              submeshIndex =
  zp_border_point_match_submesh_index[ k ][ p ][ b ]
              if( submeshIndex != numSubmeshes ) {
```

| | |
|---|---|
| zp_border_point_match_border_point_index[ k ][ p ][ b ] | u(v) |

```
                borderIndex =
  zp_border_point_match_border_point_index[ k ][ p ][ b ]
                if( submeshIndex > p)
  zipperingBorderPointMatchIndexFlag[ k ][ submeshIndex ][ borderIndex ] = 1
              }
            }
          }
        }
      }
    }
  }
}
Submesh SOI relationship indication SEI payload syntax
```

| | |
|---|---|
| submesh_soi_relationship_indication( payloadSize ) { | Descriptor |
| ssr_persistence_association_flag | u(1) |
| ssr_number_of_active_scene_objects | ue(v) |
| ssr_submesh_id_length_minus1 | ue(v) |

for( i = 0; i < ssr_number_of_active_scene_object; i++ ) {

| | |
|---|---|
| ssr_soi_object_idx[ i ] | u(v) |
| ssr_number_of_submesh_included[ i ] | ue(v) |

for( j = 0; j < ssr_number_of_submesh_included[ i ]; j++ ) {

| | |
|---|---|
| ssr_submesh_id[ i ][ j ] | u(v) |
| ssr_completely_included[ i ][ j ] | u(1) |

```
    }
  }
}
Submesh distortion indication SEI payload syntax
```

| | |
|---|---|
| submesh_distortion_indication( payloadSize ) { | Descriptor |
| sdi_number_of_submesh_indicated | ue(v) |
| sdi_submesh_id_length_minus1 | ue(v) |

for( i = 0; i < sdi_number_of_submesh_indicated; i++ ) {

| | |
|---|---|
| sdi_submesh_id[ i ] | u(v) |
| sdi_number_of_vertices_of_original_submesh[ i ] | ue(v) |
| sdi_subdivision_iteration_count[ i ] | ue(v) |
| sdi_number_of_distortion_indicated_minus1[ i ] | ue(v) |

for( j = 0; j < sdi_number_of_distortion_indicated_minus1 + 1; j++ ) {

| | |
|---|---|
| sdi_distortion_metrics_type[ i ][ j ] | u(8) |

for( k = 0; j < sdi_subdivision_iteration_count; k++ )

| | |
|---|---|
| sdi_distortion[ i ][ j ][ k ] | ue(v) |

```
    }
  }
}
```

### SEI Payload Semantics

The specifications in ISO/IEC 23090-5(2E):2023 Annex F.3 and its subclauses apply, with the following additions:

### V-DMC Registered SEI Message Semantics

Each V-DMC registered SEI message consists of the variable specifying the type vdmcPayloadType. The derived SEI message payload size vdmcPayloadSize is specified in bytes and shall be equal to the number of bytes in the V-DMC registered SEI message payload. vrsm_payload_type_byte is a byte of the payload type of an SEI message.

### V-DMC Registered SEI Payload Semantics

The V-DMC registered SEI payload provides a mechanism to include SEI messages that are specific to V-DMC toolsets.

### Zippering SEI Payload Semantics

The SEI message specifies the recommended zippering methods and their associated parameters that could be used to process the vertices of the current mesh frame after it is reconstructed, so as to obtain improved reconstructed geometry quality.

Up to 256 different zippering instances could be specified for use with each mesh frame. These instances are indicated using an array ZipperingMethod.

At the start of each sequence, let ZipperingMethod[i] be set equal to 0, where i corresponds to the zippering instance index and is in the range of 0 to 255, inclusive. When ZipperingMethod[i] is equal to 0 it means that no zippering filter is indicated for the zippering instance with index i.

zp_persistence_flag specifies the persistence of the zippering SEI message for the current layer. zp_persistence_flag equal to 0 specifies that the zippering SEI message applies to the current decoded atlas frame only.
Let aFrmA be the current atlas frame. zp_persistence_flag equal to 1 specifies that the zippering SEI message persists for the current layer in output order until any of the following conditions are true:

A new CAS begins.

The bitstream ends.

An atlas frame aFrmB in the current layer in a coded atlas access unit containing a zippering SEI message with the same value of zp_persistence_flag and applicable to the current layer is output for which AtlasFrmOrderCnt(aFrmB) is greater than AtlasFrmOrderCnt(aFrmA), where AtlasFrmOrderCnt(aFrmB) and AtlasFrmOrderCnt(aFrmA) are the AtlasFrmOrderCntVal values of aFrmB and aFrmA, respectively, immediately after the invocation of the decoding process for atlas frame order count for aFrmB.

zp_reset_flag equal to 1 resets all entries in the array ZipperingMethod to 0 and all parameters associated with this SEI message are set to their default values.
zp_instances_updated specifies the number of zippering instances that will be updated in the current zippering SEI message.
zp_instance_index[i] indicates the i-th zippering instance index in the array ZipperingMethod that is to be updated by the current SEI message.
zp_instance_cancel_flag[k] equal to 1 indicates that the value of ZipperingMethod[k] and that all parameters associated with the zippering instance with index k should be set to 0 and to their default values, respectively.
zp_method_type[k] indicates the zippering method, ZipperingMethod[k], that can be used for processing the current mesh frame as specified in Table F-2 for zippering instance with index k.

TABLE F-2
Definition of zp_method_type[k]

| Value | Interpretation |
|---|---|
| 0 | No zippering |
| 1 | Distance Zippering |
| 2 | Border Point Match Zippering |
| 3 | Reserved |

Values of zp_method_type[k] greater than 2 are reserved for future use by ISO/IEC. Decoders shall ignore zippering SEI messages that contain reserved values of zp_method_type[k]. The default value of zp_method_type[k] is equal to 0.
zp_max_match_distance[k] specifies the value of the variable zipperingMaxMatchDistance[k] used for processing the current mesh frame for zippering instance with index k when the zippering filtering process is used.
zp_send_distance_per_submesh[k] equal to 1 specifies that zippering by transmitting matching distance per submesh is applied to border points for the zippering instance with index k.
zp_send_distance_per_submesh[k] equal to 0 specifies that zippering by matching distance per submesh is not applied to border points for the zippering instance with index k. The default value of zp_send_distance_per_submesh[k] is equal to 0.
zp_number_of_submeshes[k] indicates the number of submeshes that are to be zippered by the current SEI message. The value of zp_number_of_submeshes shall be in the range from 0 to MaxNumSubmeshes[frameIdx], inclusive. The default value of zp_number_of_submeshes is equal to 0.
zp_max_match_distance_per_submesh[k][p] specifies the value of the variable zipperingMaxMatchDistancePerPatch[k][p] used for processing the current submesh with index p in the current mesh frame for zippering instance with index k when the zippering process is used. The length of the zp_max_match_distance_per_submesh[k][p] syntax element is Ceil(Log 2(zp_max_match_distance[k])) bits.
zp_send_distance_per_border_point[k] equal to 1 specifies that zippering by transmitting matching distance per border point is applied to border points for the zippering instance with index k. zp_send_distance_per_border_point[k] equal to 0 specifies that zippering by matching distance per border point is not applied to border points for the zippering instance with index k. The default value of zp_send_distance_per_border_point[k] is equal to 0.
zp_number_of_border_points[k][p] indicates the number of border points numBorderPoints[p] of a submesh with index p, in the current mesh frame for zippering instance with index k when the zippering process is used.
zp_border_point_distance[k][p][b] specifies the value of the variable zipperingMaxMatchDistancePerBorderPoint[k][p][b] used for processing the current border point with index b, in the current submesh with index p, in the current mesh frame for zippering instance with index k when the zippering process is used. The length of the zp_border_point_distance[k][p][b] syntax element is Ceil(Log 2(zp_max_match_distance_per_submesh[k][p])) bits.
zp_border_point_match_submesh_index[k][p][b] specifies the value of the variable zipperingBorderPointMatchSubmeshIndex[k][p][b] used for processing the current border point with index b, in the current submesh with index p, in the current mesh frame for zippering instance with index k when the zippering process is used. The length of the zp_border_point_match_submesh_index[k][p][b] syntax element is Ceil(Log 2(zp_number_of_submeshes[k]+1)) bits.
zp_border_point_match_border_point_index[k][p][b] specifies the value of the variable zipperingBorderPointMatchBorderPointIndex[k][p][b] used for processing the current border point with index b, in the current patch with index p, in the current mesh frame for zippering instance with index k when the zippering filtering process is used The length of the zp_border_point_match_border_point_index[k][p][b] syntax element is Ceil(Log 2(zp_number_of_border_points[k][zp_border_point_match_submesh_index[k][p][b]])) bits.

### Submesh SOI Relationship Indication SEI Message Semantics

The SEI message indicates the relationship between scene objects and submesh. One or more submesh can be associated to each scene objects and a submesh can be associated with more than one scene objects.

ssr_persistence_association_flag indicates the relationship between the scene objects and submeshes are persistent. When the value of this flag is ‘0’ the relationship is only valid for the current frame.
ssr_number_of_active_scene_object indicates the number of active scene object defined for a mesh at the time of SEI message is signalled.
ssr_submesh_id_length_minus1 plus 1 specifies the number of bits used to represent the syntax element ssr_submesh_id[i][j].
ssr_soi_object_idx[i] indicates the index of the i-th scene object to be associated with the submeshes.
ssr_number_of_submesh_included[i] indicates the number of submesh fully included in the i-th scene object.
ssr_submesh_id[i][j] indicates the identifier of a j-th submesh included in the i-th scene object.
The number of bits used to represent ssr_submesh_id[i][j] is ssr_submesh_id_length_minus1+1.
ssr_completely_included[i][j] indicates the j-th submesh is completely included in the i-th scene object.

### Submesh Distortion Indication SEI Message Semantics

The SEI message indicates the number of vertices of original submesh and the similarity of the basemesh and original mesh at each subdivision iterations so that the decoder can estimate the loss of quality of decoded submesh. In some cases, reconstruction process can be stopped at certain number of iterations by using similarity information provided by this SEI message when estimated quality of reconstructed submesh is sufficient for intended use.

sdi_number_of_submesh_indicated indicates the number of submesh similarity information signalled by this SEI message.
sdi_submesh_id_length_minus1 plus 1 specifies the number of bits used to represent the syntax element sdi_submesh_id[i].
sdi_submesh_id[i] indicates the identifier of the i-th submesh. The number of bits used to represent sdi_submesh_id[i] is sdi_submesh_id_length_minus1+1.
sdi_number_of_vertices_of_original_submesh[i] indicates the number of vertices of original submesh
sdi_subdivision_iteration_count[i] indicates the number of subdivision iteration to be applied to generate reconstructed basemesh.
sdi_number_of_distortion_indicated_minus1[i] plus 1 indicates the number of distortion associated with i-th submesh signalled by this SEI message.
sdi_distortion_metrics_type[i][j] indicates the type of distortion metric for the j-th distortion of the i-th submesh. Available types are listed in Table F-3.

TABLE F-3
Metric distortion

| value | metric |
|---|---|
| 0x00 | reserved |
| 0x01 | point cloud based D1 |
| 0x02 | point cloud based D2 |
| 0x03 | point cloud based PSNR |
| 0x04 | rendered image based PSNR |
| 0x05 | perceptual based distortion |
| 0x06-0xFF | reserved |

sdi_distortion[i][j][k] indicates the j-th distortion metric between original mesh and reconstructed j-th submesh after k-th subdivision iteration is done.

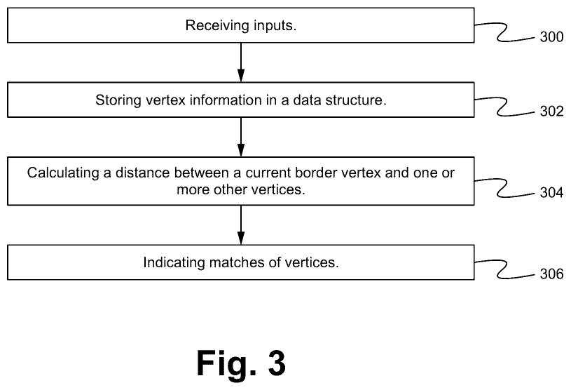

FIG. 3 illustrates a flowchart of a method of implementing a fast search algorithm according to some embodiments. In the step 300, inputs are received (e.g., at a decoder) such as: a vertex count (e.g., how many vertices there are), a submesh count (e.g., how many submeshes there are), reconstructed vertex coordinates, an indication of whether the vertex is a boundary or not, and others.

In the step 302, vertex information is stored in one or more data structures (e.g., array). In some embodiments, all of the vertices are stored in the data structure. In some embodiments, all of the vertices that are part of the boundary are stored in a data structure (e.g., array). Vertices that are on the boundary are able to be indicated using a flag or other indicator. Additionally, whether a vertex has been matched yet (to another vertex) is also able to be indicated (e.g., using a flag). Which submesh a vertex belongs to is also able to be indicated and stored. In some embodiments, all of the vertices are stored in the data structure, and the boundary vertices are given a lower index or are indicated in a way to differentiate them from the non-boundary vertices.

In the step 304, a distance between a current border vertex is calculated with one or more other vertices. If the maximum distance between two border vertices of two separate submeshes is zero, then there is no need do zippering.

Based on a maximum distance per submesh or boundary vertex, a boundary distance vector is populated which indicates the maximum distance to search for the closest boundary vertex to match.

The search for nearest vertices only occurs for boundary vertices. If a vertex is not a boundary vertex, then the process skips to the next vertex. For boundary vertices, the submesh that the vertex belongs to and which boundary ID the vertex has.

In the step 306, the output of the process indicates which vertices match with other vertices. For vertices where there is no match because the distance is zero, then no match is indicated, since the vertices will not change.

The data structure is initialized with each vertex as having no match. For each vertex, all nearest points of other submeshes are found. In some embodiments, vertices near another vertex are stored in an ascending order in a data structure such that only the nearest vertex's distance to the current vertex is analyzed to determine if it is less than a threshold distance. Vertices from the same submesh as the current vertex being analyzed are ignored. Only boundary points from other submeshes are used for matches. If a vertex from another submesh is found, then the distance from the current vertex to the vertex in the other submesh is calculated (e.g., determining the square of the difference between the vertex positions). After the distance is calculated, then it is determined if the calculated distance is smaller than a designated minimum distance. If the calculated distance is smaller than the designated distance, then the calculated distance is recorded, and a match is indicated. If the calculated distance is greater than the designated distance, then the vertex is ignored (e.g., not a match). In some embodiments, the vertex which is determined to be a match (e.g., is on a different submesh and has a distance less than the minimum distance) is checked as to whether it has already been matched with another vertex. Prior to performing the search for each vertex, it is determined if the vertex already has a match. For example, if a vertex already has a match or if a vertex is not a border vertex, then there is no need to perform a search for that vertex, so the vertex is skipped in terms of searching for a match.

In some embodiments, fewer or additional steps are implemented. For example, the matched points are used to perform zippering which fuses the matched borders and enables a mesh sequence to be reconstructed without gaps or holes. In some embodiments, the order of the steps is modified.

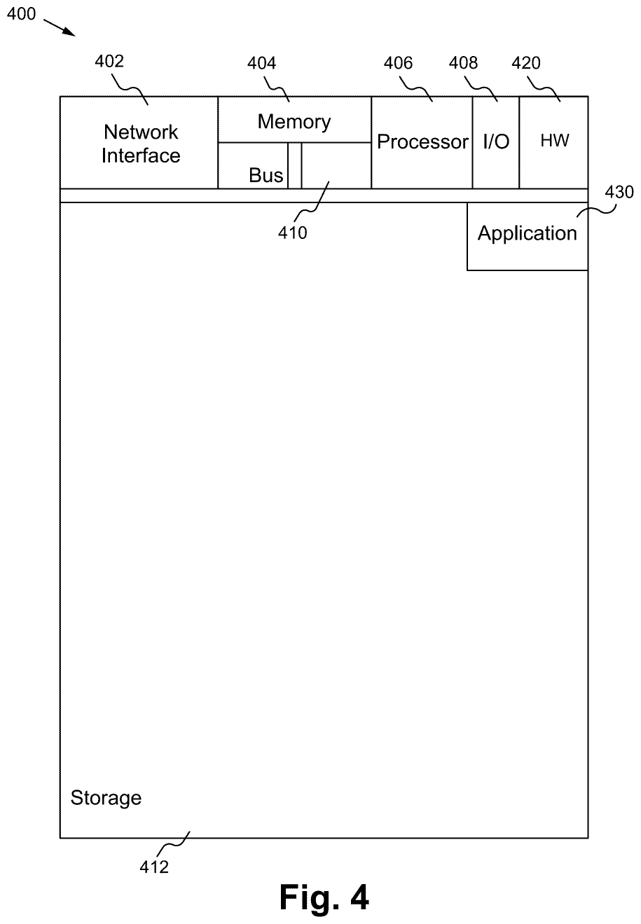

FIG. 4 illustrates a block diagram of an exemplary computing device configured to implement the mesh zippering method according to some embodiments. The computing device 400 is able to be used to acquire, store, compute, process, communicate and/or display information such as images and videos including 3D content. The computing device 400 is able to implement any of the encoding/decoding aspects. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. Mesh zippering application(s) 430 used to implement the mesh zippering implementation are likely to be stored in the storage device 412 and memory 404 and processed as applications are typically processed. More or fewer components shown in FIG. 4 are able to be included in the computing device 400. In some embodiments, mesh zippering hardware 420 is included. Although the computing device 400 in FIG. 4 includes applications 430 and hardware 420 for the mesh zippering implementation, the mesh zippering method is able to be implemented on a computing device in hardware, firmware, software or any combination thereof. For example, in some embodiments, the mesh zippering applications 430 are programmed in a memory and executed using a processor. In another example, in some embodiments, the mesh zippering hardware 420 is programmed hardware logic including gates specifically designed to implement the mesh zippering method.

In some embodiments, the mesh zippering application(s) 430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the mesh zippering method, a device acquires or receives 3D content (e.g., point cloud content). The mesh zippering method is able to be implemented with user assistance or automatically without user involvement.

In operation, the mesh zippering method enables more efficient and more accurate 3D content decoding compared to previous implementations. The mesh zippering method is able to utilize a fast search algorithm which ignores vertices that are already matches, ignores vertices with a distance greater than a limit and is only utilized for border vertices.

### Some Embodiments of Zippering SEI Message

1. A method programmed in a non-transitory memory of a device comprising:
storing vertex information in a data structure;
determining a distance between a current vertex and a second vertex;
indicating a match between the current vertex and the second vertex when the distance is less than a threshold; and
fusing matched borders based on the match between the current vertex and the second vertex.
   2. The method of clause 1 further comprising receiving input information including:
a vertex count;
a submesh count;
vertex coordinates; and
an indicator of a boundary vertex, wherein the input information is utilized for fusing matched borders.
   3. The method of clause 2 wherein when the indicator of the boundary vertex indicates that the current vertex is not a boundary vertex, then the current vertex is skipped.
   4. The method of clause 1 wherein when a match is indicated for the current vertex based on a previous vertex match, then the current vertex is skipped.
   5. The method of clause 1 wherein when the distance between the current vertex and the second vertex is zero, the current vertex is skipped.
   6. The method of clause 1 further comprising comparing an index of a submesh of the current vertex and the index of the submesh of the second vertex, and when the index of the submesh of the current vertex and the index of the submesh of the second vertex are the same, the second vertex is skipped.
   7. The method of clause 1 wherein the data structure comprises an array.
   8. An apparatus comprising:
a non-transitory memory for storing an application, the application for:
   storing vertex information in a data structure;
   determining a distance between a current vertex and a second vertex;
   indicating a match between the current vertex and the second vertex when the distance is less than a threshold; and
   fusing matched borders based on the match between the current vertex and the second vertex; and
a processor coupled to the memory, the processor configured for processing the application.
   9. The apparatus of clause 8 wherein the application is further configured for receiving input information including:
a vertex count;
a submesh count;
vertex coordinates; and
an indicator of a boundary vertex, wherein the input information is utilized for fusing matched borders.
   10. The apparatus of clause 9 wherein when the indicator of the boundary vertex indicates that the current vertex is not a boundary vertex, then the current vertex is skipped.
   11. The apparatus of clause 8 wherein when a match is indicated for the current vertex based on a previous vertex match, then the current vertex is skipped.
   12. The apparatus of clause 8 wherein when the distance between the current vertex and the second vertex is zero, the current vertex is skipped.
   13. The apparatus of clause 8 wherein the application is further configured for comparing an index of a submesh of the current vertex and the index of the submesh of the second vertex, and when the index of the submesh of the current vertex and the index of the submesh of the second vertex are the same, the second vertex is skipped.
   14. The apparatus of clause 8 wherein the data structure comprises an array.
   15. A system comprising:
an encoder configured for encoding content; and
a decoder configured for:
   storing vertex information of the content in a data structure;
   determining a distance between a current vertex and a second vertex;
   indicating a match between the current vertex and the second vertex when the distance is less than a threshold; and
   fusing matched borders based on the match between the current vertex and the second vertex.
      16. The system of clause 15 wherein the decoder is further configured for receiving input information including:
a vertex count;
a submesh count;
vertex coordinates; and
an indicator of a boundary vertex, wherein the input information is utilized for fusing matched borders.
   17. The system of clause 16 wherein when the indicator of the boundary vertex indicates that the current vertex is not a boundary vertex, then the current vertex is skipped.
   18. The system of clause 15 wherein when a match is indicated for the current vertex based on a previous vertex match, then the current vertex is skipped.
   19. The system of clause 15 wherein when the distance between the current vertex and the second vertex is zero, the current vertex is skipped.
   20. The system of clause 15 wherein the decoder is further configured for comparing an index of a submesh of the current vertex and the index of the submesh of the second vertex, and when the index of the submesh of the current vertex and the index of the submesh of the second vertex are the same, the second vertex is skipped.
   21. The system of clause 15 wherein the data structure comprises an array.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
storing vertex information in a data structure;
determining a distance between a current vertex and a second vertex;
indicating a match between the current vertex and the second vertex when the distance is less than a threshold; and
fusing matched borders based on the match between the current vertex and the second vertex.

2. The method of claim 1 further comprising receiving input information including:
a vertex count;
a submesh count;
vertex coordinates; and
an indicator of a boundary vertex, wherein the input information is utilized for fusing matched borders.

3. The method of claim 2 wherein when the indicator of the boundary vertex indicates that the current vertex is not a boundary vertex, then the current vertex is skipped.

4. The method of claim 1 wherein when a match is indicated for the current vertex based on a previous vertex match, then the current vertex is skipped.

5. The method of claim 1 wherein when the distance between the current vertex and the second vertex is zero, the current vertex is skipped.

6. The method of claim 1 further comprising comparing an index of a submesh of the current vertex and the index of the submesh of the second vertex, and when the index of the submesh of the current vertex and the index of the submesh of the second vertex are the same, the second vertex is skipped.

7. The method of claim 1 wherein the data structure comprises an array.

8. An apparatus comprising:
a non-transitory memory for storing an application, the application for:
storing vertex information in a data structure;
determining a distance between a current vertex and a second vertex;
indicating a match between the current vertex and the second vertex when the distance is less than a threshold; and
fusing matched borders based on the match between the current vertex and the second vertex; and
a processor coupled to the memory, the processor configured for processing the application.

9. The apparatus of claim 8 wherein the application is further configured for receiving input information including:
a vertex count;
a submesh count;
vertex coordinates; and
an indicator of a boundary vertex, wherein the input information is utilized for fusing matched borders.

10. The apparatus of claim 9 wherein when the indicator of the boundary vertex indicates that the current vertex is not a boundary vertex, then the current vertex is skipped.

11. The apparatus of claim 8 wherein when a match is indicated for the current vertex based on a previous vertex match, then the current vertex is skipped.

12. The apparatus of claim 8 wherein when the distance between the current vertex and the second vertex is zero, the current vertex is skipped.

13. The apparatus of claim 8 wherein the application is further configured for comparing an index of a submesh of the current vertex and the index of the submesh of the second vertex, and when the index of the submesh of the current vertex and the index of the submesh of the second vertex are the same, the second vertex is skipped.

14. The apparatus of claim 8 wherein the data structure comprises an array.

15. A system comprising:
an encoder configured for encoding content; and
a decoder configured for:
storing vertex information of the content in a data structure;
determining a distance between a current vertex and a second vertex;
indicating a match between the current vertex and the second vertex when the distance is less than a threshold; and
fusing matched borders based on the match between the current vertex and the second vertex.

16. The system of claim 15 wherein the decoder is further configured for receiving input information including:
a vertex count;
a submesh count;
vertex coordinates; and
an indicator of a boundary vertex, wherein the input information is utilized for fusing matched borders.

17. The system of claim 16 wherein when the indicator of the boundary vertex indicates that the current vertex is not a boundary vertex, then the current vertex is skipped.

18. The system of claim 15 wherein when a match is indicated for the current vertex based on a previous vertex match, then the current vertex is skipped.

19. The system of claim 15 wherein when the distance between the current vertex and the second vertex is zero, the current vertex is skipped.

20. The system of claim 15 wherein the decoder is further configured for comparing an index of a submesh of the current vertex and the index of the submesh of the second vertex, and when the index of the submesh of the current vertex and the index of the submesh of the second vertex are the same, the second vertex is skipped.

21. The system of claim 15 wherein the data structure comprises an array.
